(19) United States
(12) Patent Application Publication
(10) Pub. No.: US 2002/0090985 A1
(43) Pub. Date: Jul. 11, 2002

(54) Coexistent interaction between a virtual character and the real world

(76) Inventors: Ilan Tochner, Mevassert Zion (IL); Michael Kagan, Jerusalem (IL); Robert Anders, Jerusalem (IL); Ari Gottesman, Jerusalem (IL)

Correspondence Address: Bernhard D. Saxe, FOLEY & LARDNER, Washington Harbour, 3000 K Street, N.W., Suite 500, Washington, DC, 20007-5109, US

(21) Appl. No.: 09/946,959

(22) Filed: Sep. 6, 2001

Related U.S. Application Data
(60) Provisional application No. 60/230,667, filed on Sep. 7, 2000.

(51) Int. Cl. A63F 13/00

(52) U.S. Cl. 463/1; 463/9; 463/42

(57) ABSTRACT

A game system, incorporating co-existent interaction between a virtual character 20 and a user 10 in the real world, comprising a virtual character 20 in a computer sub-system 12,14 including a computer device 12 and means 38,40,42 for inputting real-world actions of a user in the real world into said sub-system 12,14, whereby actions of a user in the real world, at a pre-chosen real world location 36, other than correlative movements, are recorded and inputted into the computer sub-system and influence the character 20 in the virtual world 16.

This application claims priority from provisional U.S. Application Serial No. 60/230,667 filed Sep. 7, 2000, incorporated herein by reference in its entirety.

### FIELD OF INVENTION

The invention pertains to a game system incorporating co-existent interaction between a virtual character and a user in the real world. More specifically, the present invention incorporates means of influencing a Virtual Character resident in virtual, cyber space through the everyday actions of a Real Character resident in real space. The invention pertains to the creation and continued existence of a Virtual Character in a computer device including a personal computer (PC), a personal digital assistant (PDA), mobile phone, mainframe and purpose-built gaming machine, whose behavior is influenced in a non-correlative way by the actions of a user of the device wherein such ways include shopping, traveling, and meeting other users with the purpose of exchanging information.

### BACKGROUND

There are many known forms of computer and especially digital environments, which comprise virtual characters directly controlled by a real game player. These characters may have names and individual personalities. During the execution of a game these characters fulfill certain roles according to the rules of the game. The player of the game controls the virtual characters by means of inputting data into the gaming machine by various analogue means, for instance: keyboard strokes, joy stick movements, mouse movements, screen contact, speech recognition. These input methods are digitized and result in influencing the virtual character within the gaming environment of its existence. These results are commonly displayed in graphic form or as text on a device screen. Such influence includes moving the character around a gaming space; interaction with other characters including fighting, shooting, and exchanging information or articles; equipping the character with needs including nourishment, strength, information, authority, weapons, money, bargaining tools, and various powers. Other virtual characters are controlled exclusively by the playing machine and act randomly or react in response to moves made by an externally controlled character; whereas other characters are controlled sometimes by the playing machine and sometimes by the external player. Examples of such characters include the Tamagotchi® virtual pet, the Webamushi®, Bonzi Gorilla®, and the Furby® Doll.

The Tamagotchi® is a stand-alone, hand held, electronic device whose software emulates a virtual character such as a pet animal. This character has a pseudo personality in that it has virtual sleep cycles, virtual eating cycles and virtual play cycles. The player or owner of such a virtual pet must maintain the virtual character, including eating, sleeping, playing, and washing, by directly inputting information by means of depressing buttons on the device.

The Webamushi® is a similar innovation where a virtual character resides in a handheld, mobile communication device, in particular a Wireless Application Protocol (WAP) phone. It's virtual existence and virtual well-being is ensured by the user's interaction with the Internet such as browsing and sending e-mails.

The Furby® doll is similar to the Tamagotchi® except that is has a greater sense of realism. The electronic device is dressed up as a furry doll with motors that allow maneuverability and a sound card that allows for vocalization. Sensors are located on its body that responds to touch and light. A switch in its beak responds to pressure thereby simulating feeding. The virtual character of the Furby® doll has virtual needs such as feeding, sleeping, and hugging. These needs are fulfilled by the user actually stroking the surface of the doll, turning on and off the lights, and sticking a spoon into its mouth. Furthermore the Furby® virtual personality expresses itself verbally. It contains a progressive software language program that mimics language development in humans so that the verbal ability of the Furby® doll becomes more sophisticated with time. It is noted that this software is not a learning program or artificial intelligence but rather accesses areas of its database containing richer vocabulary with time.

The Bonzi Gorilla® is a virtual character that is resident in a web-enabled computer. It learns the user's computing habits and interests by following the user's interaction with the Internet and reacts by audio signals, graphic movements and provides automated Internet services.

There are computer games such as Ultima® Online in which essential playing elements that include food, weapons, information and strength can be purchased on the Internet. For instance a weapon for the game was recently obtained in a web based auction for a sum of about $5000. The virtual weapon was transferred to the player as a digital packet that was then uploaded into the game.

Electronic coupons have become a popular feature of on-line commerce mimicking the bricks & mortar coupons such as stamps, vouchers, and club points. These e-coupons are acquired during Internet commercial transactions and in some cases even by accessing a web site. The coupons are redeemable through a number of means that include price reductions, free offers, and exclusive access to information. all these being confined to the virtual world of e-commerce. Consumers can earn e-coupons for performing “e-work” on-line activities such as visiting a web site, interacting with on-line businesses, shopping or simply accessing the Internet through a service provider. An example of an e-coupon is given by beenz® at beenz.com. Beenz® is designed to help web sites manage consumer behavior and customer relationships through incentive-based rewards program. They are redeemable either by the consumer receiving discounts for goods sold over the Internet or by receiving real paper vouchers that can then be used to obtain discounts in brick & mortar shops.

A further example is that of promotional coupons that are obtainable in the real world either as give-aways or as part of a purchase reward system, that are redeemable during Internet commerce.

### SUMMARY OF INVENTION

The invention described herein allows for the playing of games through the interaction of a Real Character with the Real World thereby affecting a Virtual Character in a Virtual World. Unlike other gaming systems that exist either in the Real World or in the Virtual World this invention involves the existence of a virtual personality that lives a parallel and connected existence in cyber space to that of the real user in real space. The well being of the Virtual Character is indirectly dependent upon the actions of the real character in the real world. By indirectly is implied that the interaction is not merely performed by the user depressing Keys or giving commands but by where the user travels, shops, eats, congregates, and with whom the user speaks to and exchanges information with.

Thus, according to the present invention, there is now provided a game system, incorporating co-existent interaction between a virtual character and a user in the real world, comprising a virtual character in a computer sub-system including a computer device and means for inputting real-world actions of a user in the real world into said sub-system, whereby actions of a user in the real world, at a pre-chosen real world location, other than correlative movements, are recorded and inputted into the computer sub-system and influence the character in the virtual world.

In preferred embodiments of the present invention said system incorporates at least one locator device for noting the presence of the user or a user at a pre-chosen location.

In especially preferred embodiments of the present invention the real-world actions of more than one user are inputted into the device.

As will be realized and described hereinafter, the computer sub-system and the computer device can be chosen from a variety of devices which are available and compatible for use in the game system of the present invention.

Thus, in a first series of preferred embodiments of the present invention said computer device is a mobile-device and said mobile-device is a digital mobile computer.

In a second series of preferred embodiments of the present invention said computer device is a fixed-point PC with the virtual character resident locally in the PC.

In especially preferred embodiments of the present invention said computer sub-system further comprises a server containing at least part of the logic of said game system.

Thus, in one possible embodiment of the present invention said computer device is a mobile hand-held device and the interface between the virtual character and the real world is resident in said server whereby actions of the user in the real world are inputtable into at least one of said server and said computer device, with intercommunication between said hand-held device and said server.

In a second possible embodiment of the present invention said computer device is a desk-top PC and the interface between the virtual character and the real world is resident in said server whereby actions of the user in the real world are inputtable into at least one of said server and said computer device, with intercommunication between said desk-top PC and said server.

In a third possible embodiment of the present said computer device is a mobile hand-held device and the interface between the virtual character and the real world is resident in said mobile device whereby actions of the user in the real world are inputtable into at least one of said server and said computer device, with intercommunication between said desk-top PC and said server.

In a fourth possible embodiment of the present invention said computer device is a desk-top PC and the interface between the virtual character and the real world is resident in said desk-top PC whereby actions of the user in the real world are inputtable into at least one of said server and said computer device, with intercommunication between said desk-top PC and said server.

In a fifth possible embodiment of the present said computer sub-system comprises a desk-top PC and a hand-held device.

Preferably in this embodiment said desk-top PC and hand-held device are both provided with Bluetooth technology.

As will become apparent from the specification hereinafter and especially with reference to the accompanying figures, the game system of the present invention provides for many possibilities, including those in which the Virtual Character is part of an overall gaming scenario resident on a server; wherein the interaction platform between the Real Character and the Virtual Character is a mobile device including a web-enabled PDA and a Wireless Application Protocol (WAP) phone; wherein the mobile device is location sensitive by methods including Global Positioning System (GPS), Differential Global Positioning System (DGPS), and server side referencing, and has point-to-point communication capability including Infrared Data Assistant (IrDA), Bluetooth, and Digital Enhanced Cordless Telecommunications (DECT). In such an embodiment the Virtual Character is affected by the actions of the user including the user's geographical location, receiving of gaming coupons as a result of the user's shopping habits, the user's life-style, the user's personal profiles the profiles of other real world characters, time, events and the direct electronic transfer of gaming information with others.

Thus, in preferred embodiments of the present invention said inputting into said device can be effected by means selected from the group consisting of IR transmission, rf transmission, wired synching, scanning and manual input.

In especially preferred embodiments of the present invention said locator device, mentioned hereinbefore, includes means selected from a global positioning system, a differential global positioning system, server-side referencing, time of arrival detectors, enhanced observed time difference detectors, cell of origin detectors, IR transmitters, hard-wire synchronization means, manual entry of location means, manual code entry means and a Bluetooth personal access network and combinations thereof.

Thus, an especially preferred embodiment can comprise at least one locator device which includes a combination of a global positioning system and Bluetooth transmitters/receivers.

A further embodiment is described wherein the Virtual Character has its own independent existence as a stand-alone virtual being outside a gaming scenario and is resident on a server. In such a case the hand-held device is web-enabled with point-to-point communications capability and locator technology as described in the preferred embodiment.

A further embodiment is described wherein the Virtual Character has its own independent existence as a stand alone virtual being outside a gaming scenario and is resident locally in the hand-held device. In such a case the hand-held device has point-to-point communications capability and locator technology as described in the preferred embodiment.

A further embodiment is described wherein the Virtual Character is part of a gaming scenario resident locally in the hand-held device, in which the other characters in the game are controlled by the gaming software. In such a case the hand-held device has point-to-point communications capability as described in the preferred embodiment.

A further embodiment is described wherein the interaction platform between the Real Character and the Virtual Character is a fixed-point PC with the Virtual Character resident locally in the PC. Input to the Virtual Character is made via means including promotional coupons acquired as a consequence of brick & mortar commerce. Such coupons include printed matter containing at least one alphanumeric string that is transferred to the computer by methods including typing via the keyboard and speech-to-text input via a microphone; and digital coupons that are transferred to a hand-held device by methods including wire and wireless data transfer and are then transferred from the hand-held device to the PC by methods including wire and wireless data transfer. Other means include a hand-held device that transfers data between the Real World and the PC by means described above.

A still further embodiment is described wherein the interaction platform between the Real Character and the Virtual Character is a fixed-point PC with the Virtual Character resident on the Internet and access is via a connection to the Internet. Input to the virtual character is as described in the previous embodiment.

As is known, many patents exist relating to interaction between a virtual character and a user in the real world, such as US Patent 6,080,063, which teaches a game system for simulated real time game play with a live event. More specifically this patent involves a one-to-one correspondence between a live event and a computer game. The events in the real world are detected by a variety of sensors and this data is transmitted to the gaming computer via a server. It thus allows a user to participate in a concurrent simulation of a real event. It differs from the present invention in that it is a simulation of real events with a close mapping factor. U.S. Pat. No. 5,913,727 teaches the interaction between a real user and activities in virtual space by means of sensors attached to the user. The user's movements and position are detected and relayed to the computer. The virtual player responds directly to the movements of the real player and as such this is a one-to-one mapping system. U.S. Pat. No. 6,149,490 teaches an electronic toy with a variety of sensors on its body enabling it to have life-like mannerisms. It differs from the present invention in that the sensors act regular input stroke keys directly inputting electric signals into a CPU running a software program. U.S. Pat. No. 6,227,966 teaches a virtual creature resident in a toy device where the virtual creature responds to inputs from a real user. The inputs are directly into the CPU even though the results may not correlate (i.e. random influence). It differs from the present invention in that he system does not extend beyond the boundaries of the device and the inputs are through key-like switches. U.S. Pat. No. 5,942,969 teaches a computerized locating network that allows a real world treasure hunt to occur. A user's location is detected using hand held devices and the user is fed clues accordingly. It differs from the present invention in that no interaction occurs with a virtual reality. U.S. Pat. No. 6,183,364 teaches a multi-user gaming platform with a rich, variable environment that allows a large variety of virtual characters. It differs from the present invention in that the input of information into the virtual world is by direct, correlated means. U.S. Pat. No. 6,200,216 teaches the use of electronic trading cards capable of carrying compact digitized identifying information that can be transferred to a computer allowing the cards to be stored in digital albums. It differs from the present invention in that there is no interaction between the cards and a virtual gaming environment. U.S. Pat. No. 4,843,568 teaches and claims an apparatus and method for using an image of the human body to control real time computer events. U.S. Pat. No. 5,247,651 teaches a computer program specification system for interactively creating program specifications -responsive to user input. U.S. Pat. No. 6,142,870 teaches a simulation game machine which relatively moves a virtual character displayed on a monitor in a gamed space in accordance with control by a player using an operational unit. As will be noted all of said patents relate to games and systems involving simulation and/or correlative movement between a user and the virtual character and do not teach or suggest the system of the present invention wherein actions of a user in the real world, at a pre-chosen real world location, other than correlative movements, are recorded and inputted into the computer sub-system and influence the character in the virtual world, and wherein in many embodiments said actions of the user are at a pre-chosen real world location external to the environment of the virtual character. It is further to be noted and will be understood from the description hereinafter and with reference to the illustrative figures that the effect and influence on the character in the virtual world is a non-mimicking effect, in contradistinction to the mimicking effect sought in simulation and similar correlative systems.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### DETAILS OF THE INVENTION

This invention relates to a method of gaming that promotes real commerce, actual travel and real human interactions in the real world by relating the activities of a real person in the real world with that of a virtual character in a virtual world scenario. Thus, by way of example only, when a Real Character participating in the invention conducts a commercial transaction there is a transfer of a digital information package into a virtual, cyber environment that effects a Virtual Character within that environment.

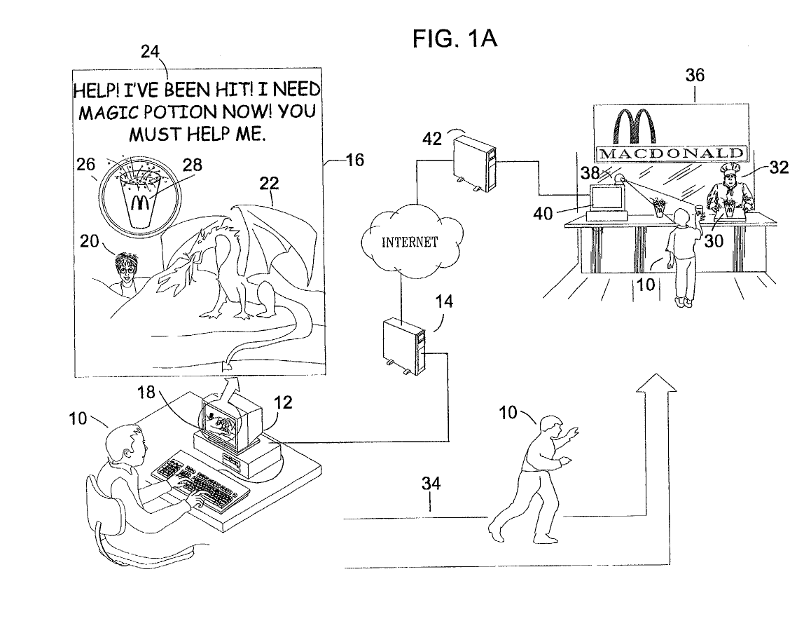

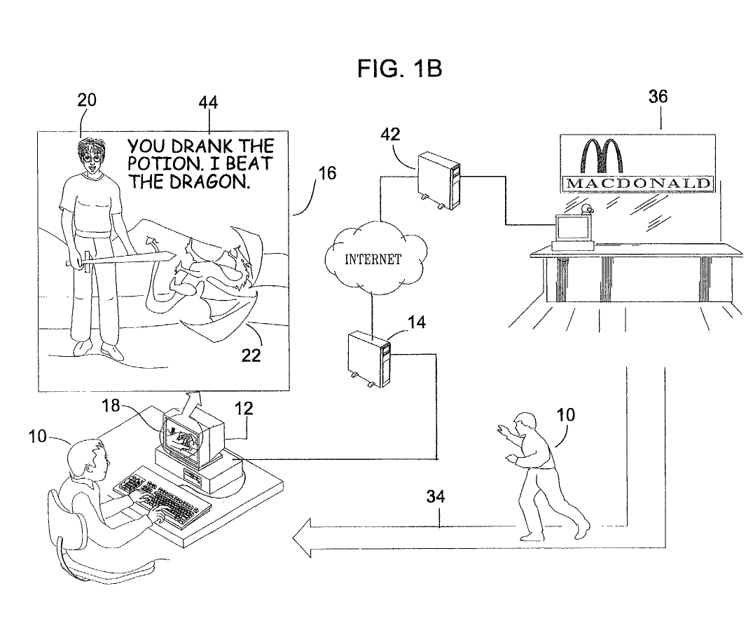

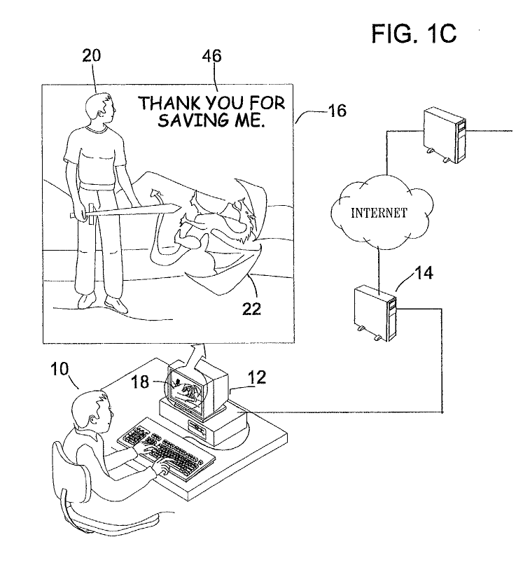

The various embodiments are described in detail in FIGS. 1-15 together with examples of implementation.

FIGS. 1A, 1B, 1C are pictorial illustrations of an embodiment of the present invention.

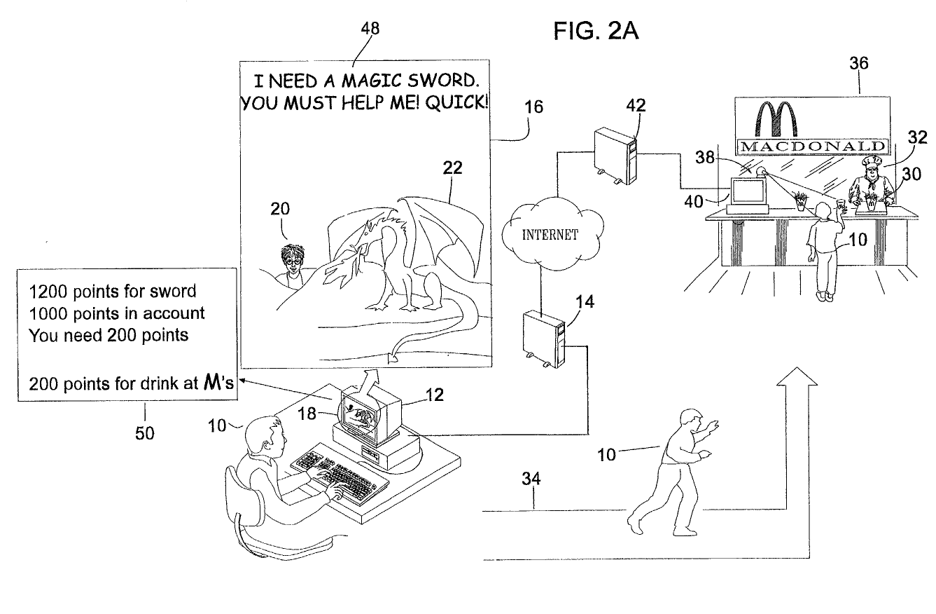

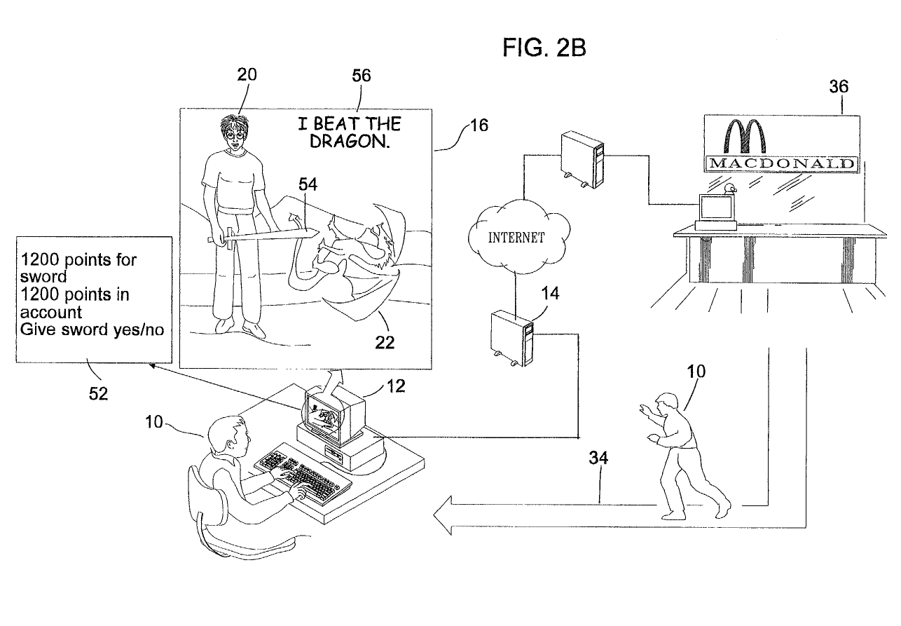

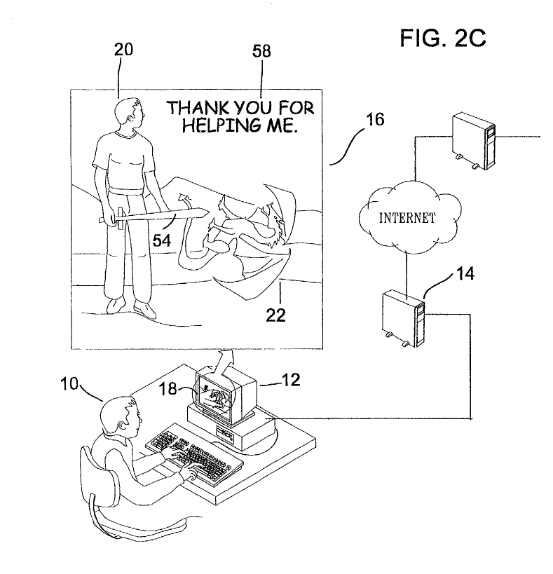

FIGS. 2A, 2B, 2C are pictorial illustrations of another embodiment of the present invention.

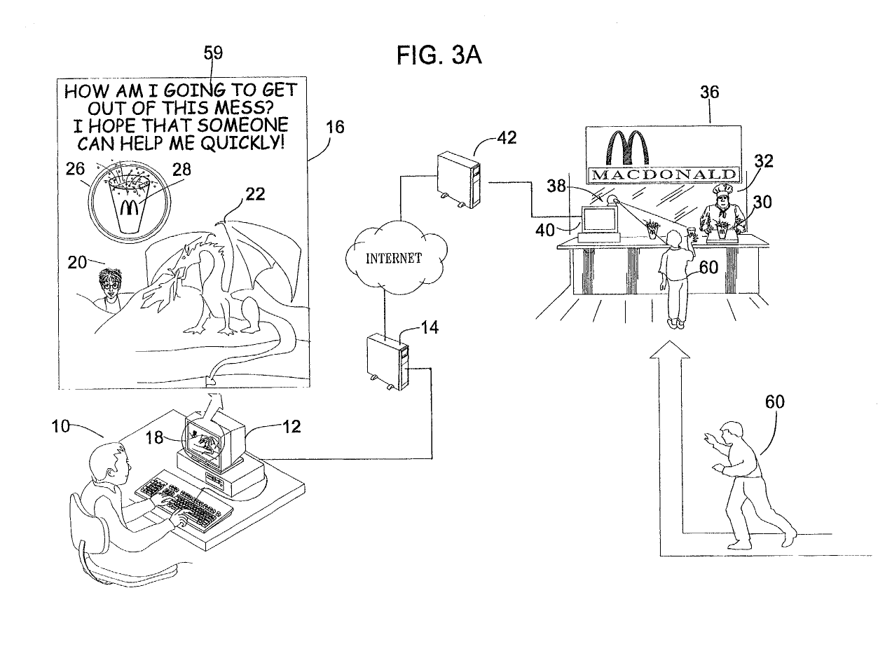

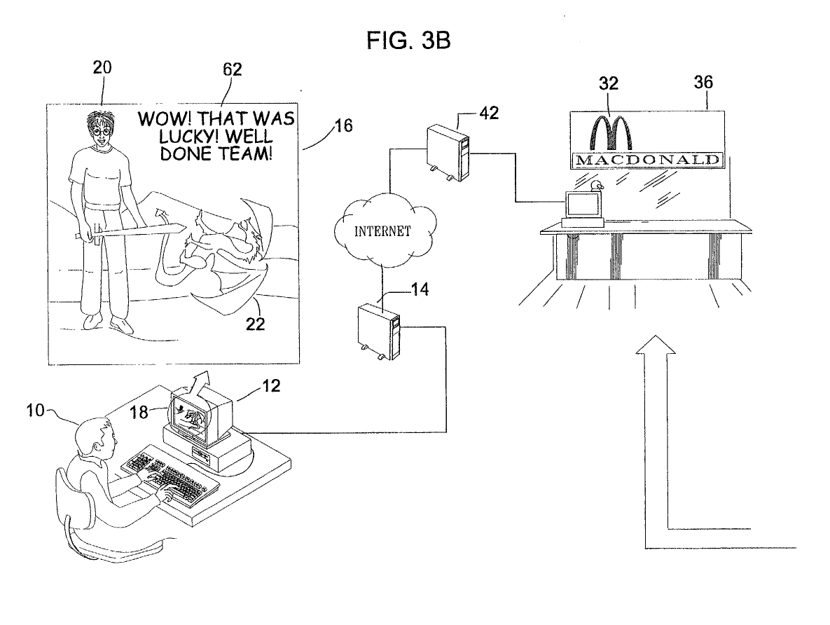

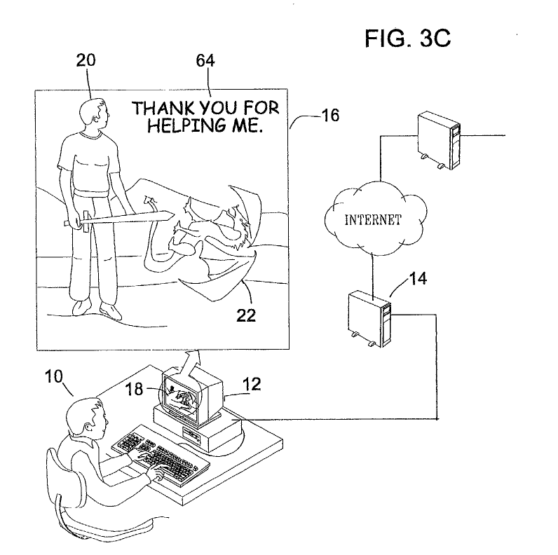

FIGS. 3A, 3B, 3C are pictorial illustrations of a further embodiment of the present invention.

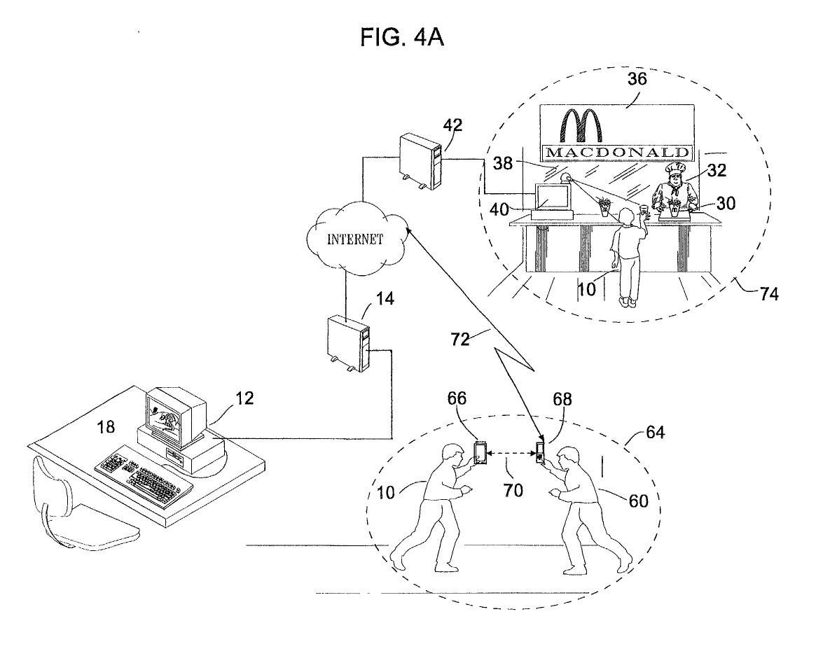

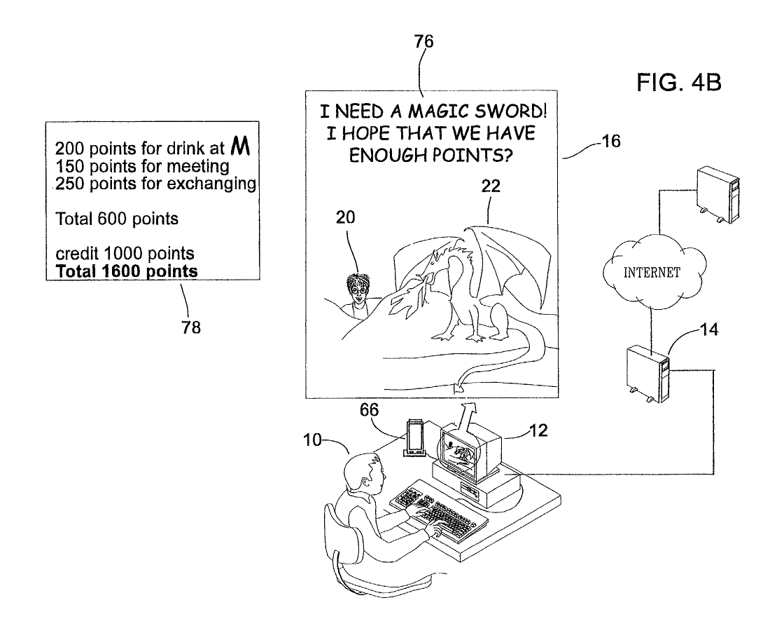

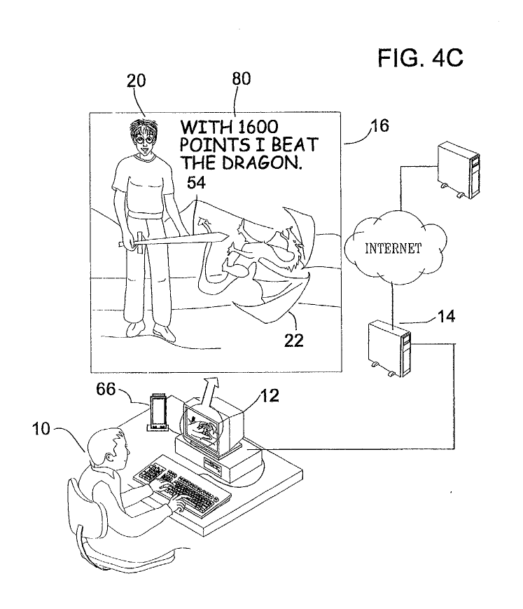

FIGS. 4A, 4B, 4C are pictorial illustrations of yet another embodiment of the present invention.

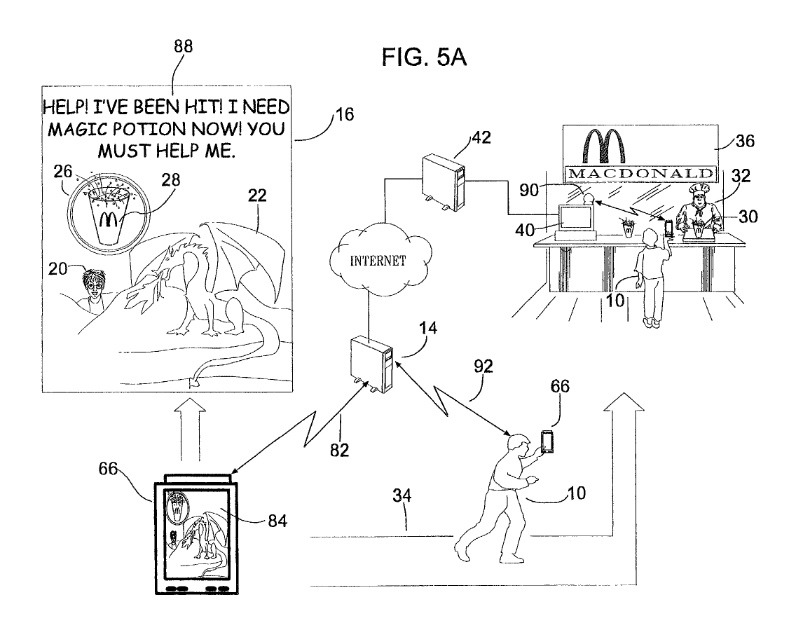

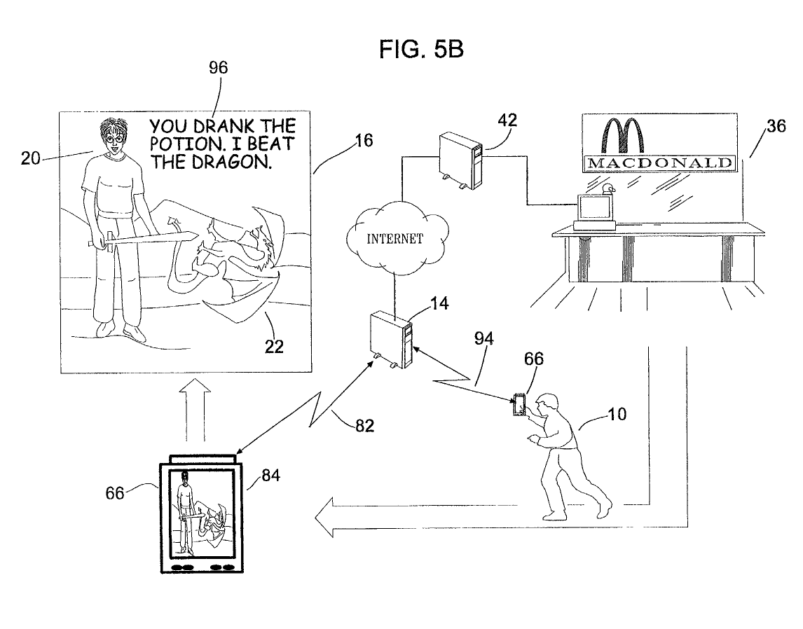

FIGS. 5A, 5B are pictorial illustrations of yet a further embodiment of the present invention.

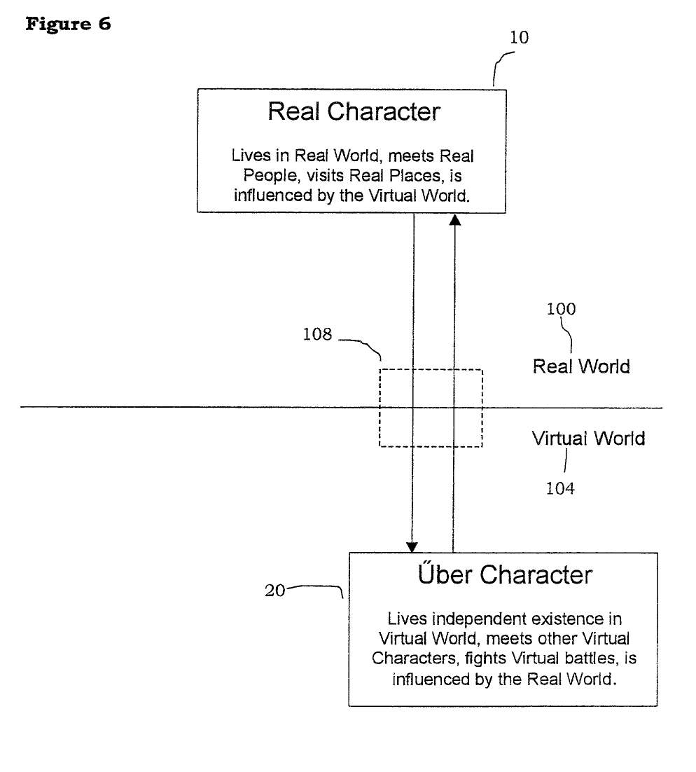

FIG. 6 shows the relationship between Real Character and Über Character described in the present invention.

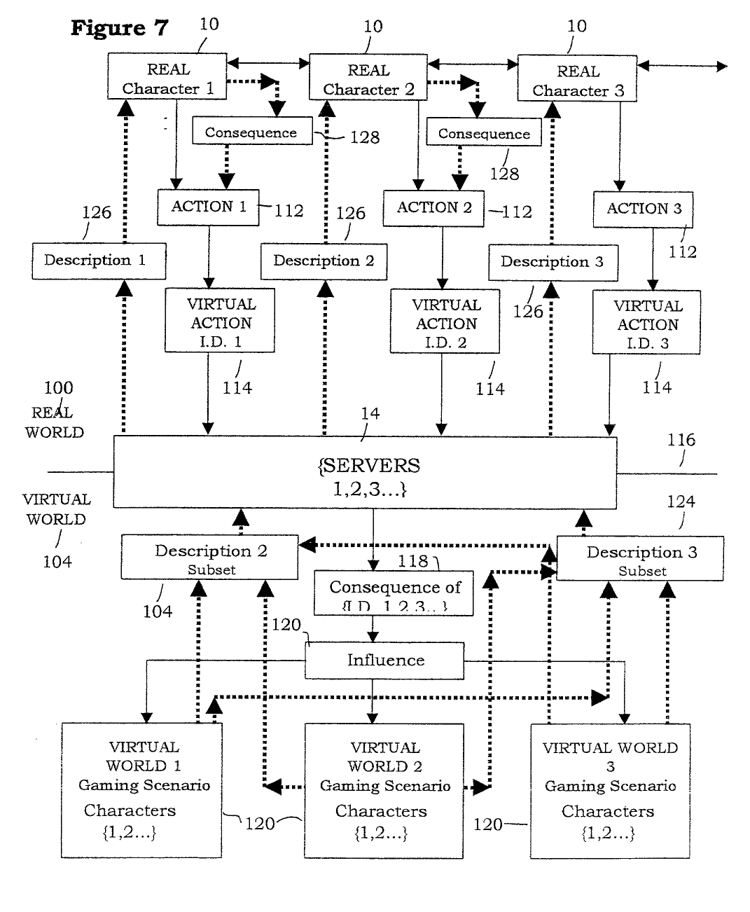

FIG. 7 is a block diagram describing the general scheme of the present invention.

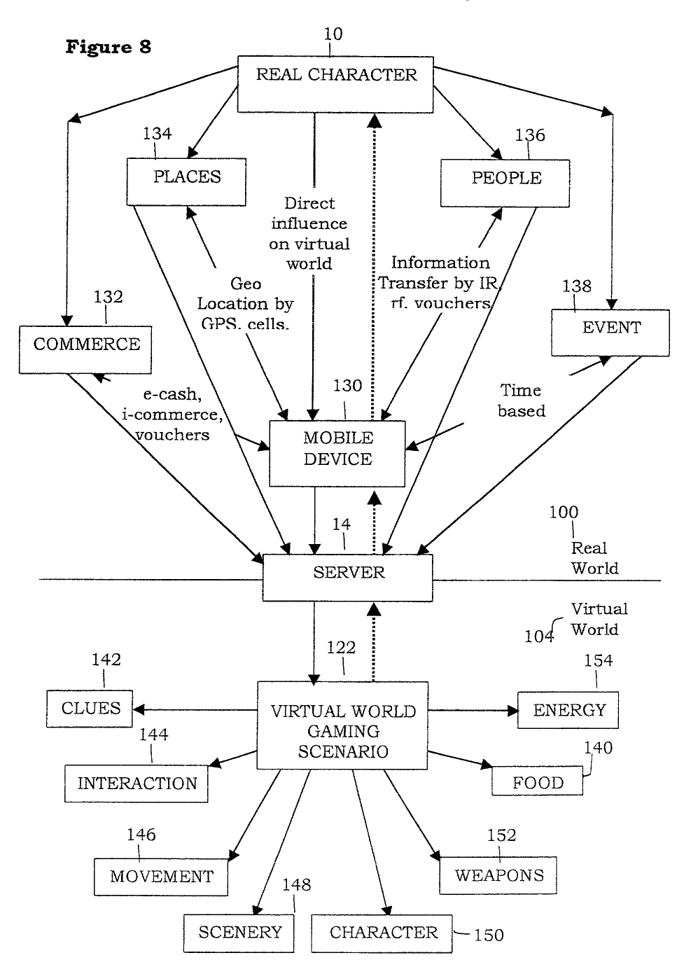

FIG. 8 is a block diagram describing the configuration of the preferred embodiment in the present invention.

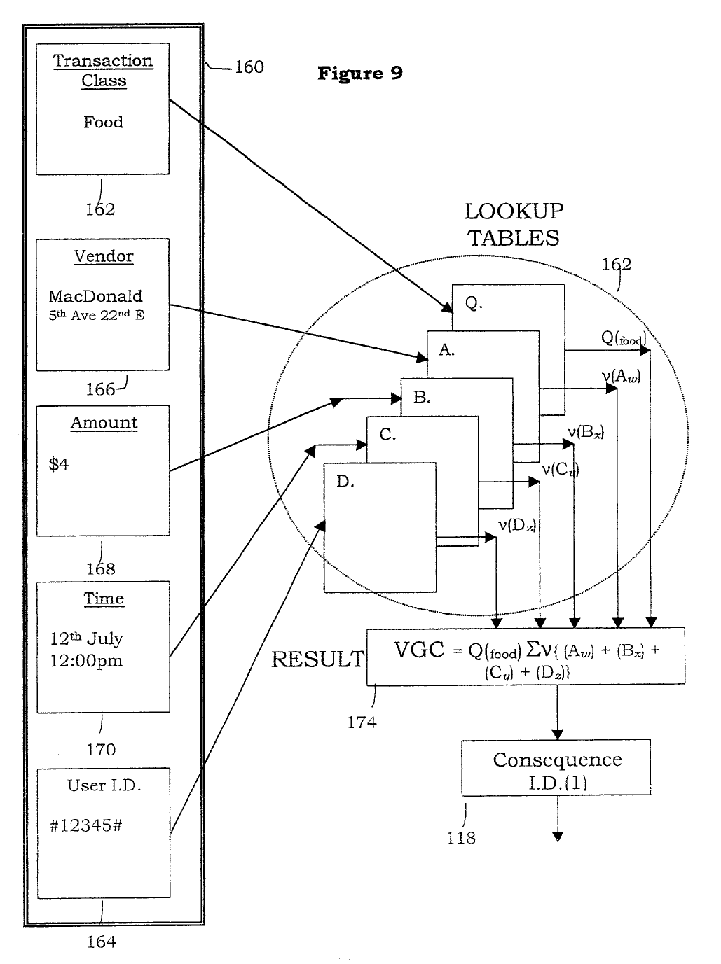

FIG. 9 is a block diagram showing the operating algorithm for the system described in the present invention.

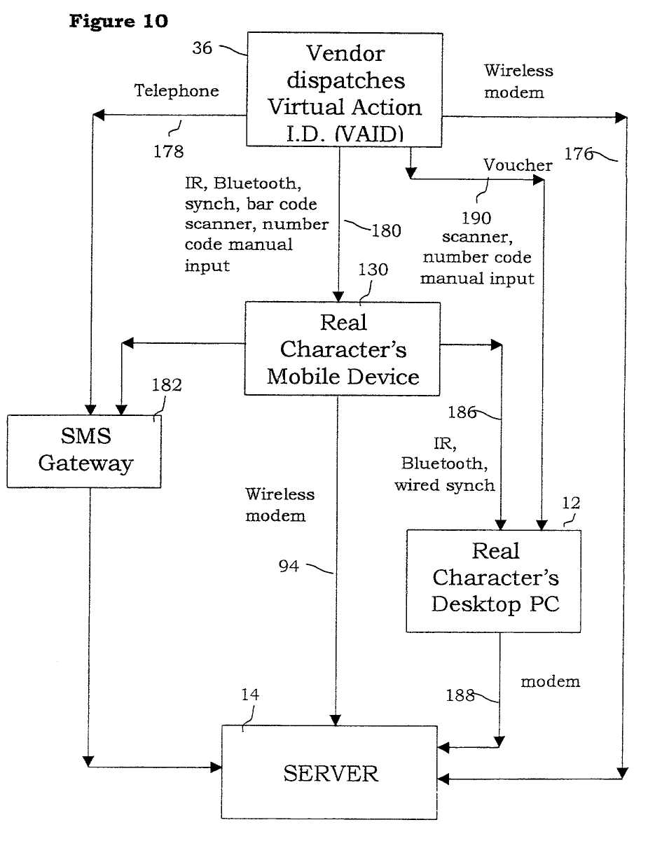

FIG. 10 is a block diagram showing the relationship between a vendor and a user of the system described in the present invention.

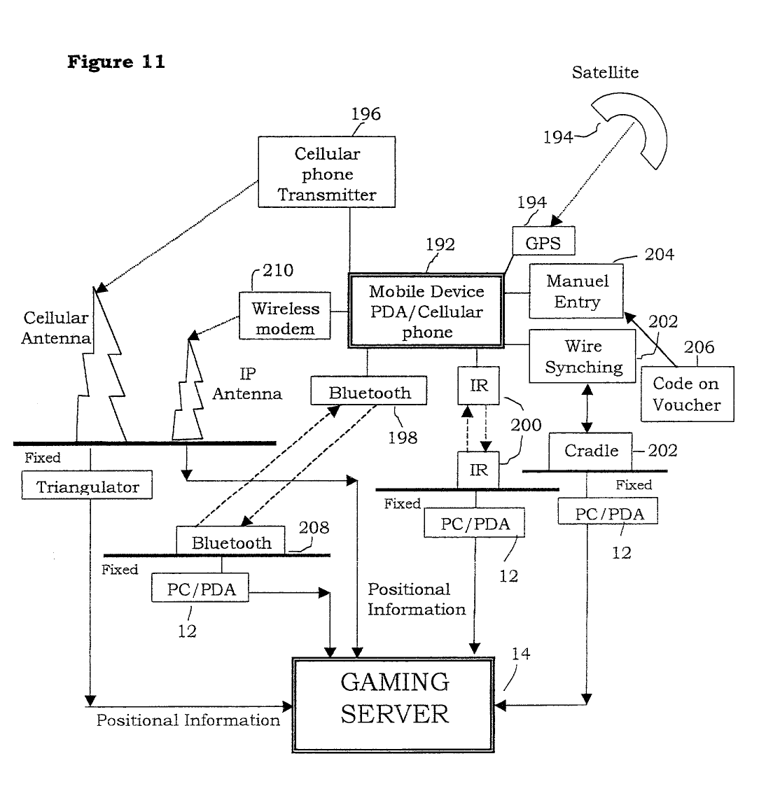

FIG. 11 is a block diagram describing the transfer of location based information within the gaming system as described in the present invention.

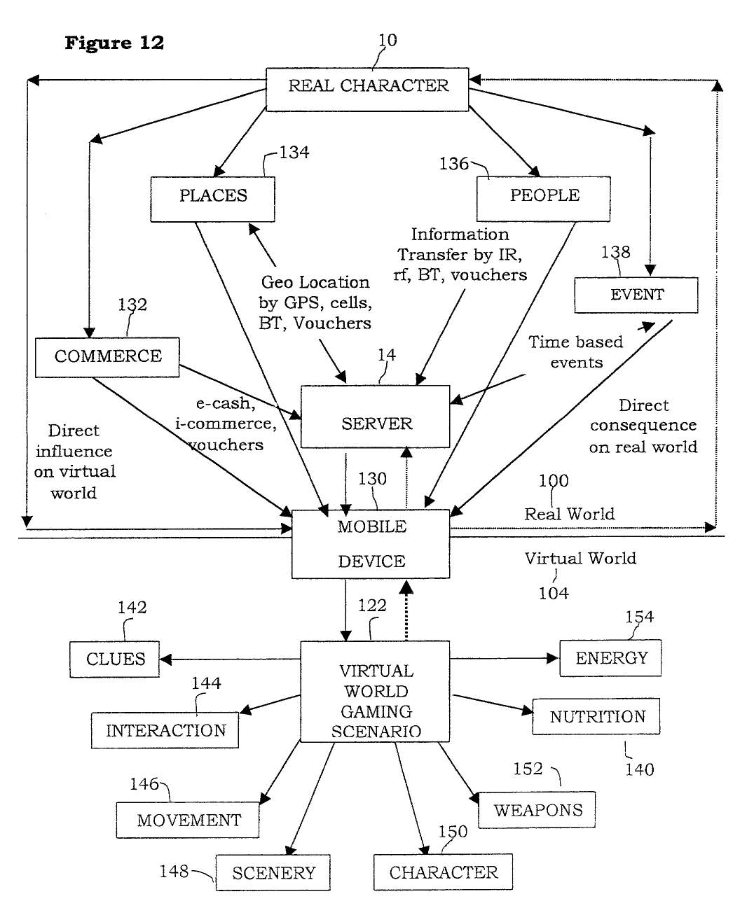

FIGS. 12, 13, 14, 15 are block diagrams describing other configurations described in the present invention.

### DETAILED DESCRIPTION OF THE FIGURES

FIG. 1A illustrates a Real Character 10 involved in a form of entertainment accessed via a desktop PC 12 in communication with a game management server 14. Shown in the enlarged detail 16 of the computer screen 18 is a scene from an imaginary game involving an Über Character 20 facing a menacing virtual dragon 22. By Real Character 10 we refer to live flesh and blood users of computerized gaming systems as described herein. The purpose of the Real Character 10 is to play the game by interacting in the real world. By Über Characters 20 we refer to artificially created digital personalities that exist within a computerized gaming program. They are not necessarily created by the Real Character 10, bear no necessary resemblance to the Real Character 10, live their virtual lives independent of the Real Character 10 but can be influenced by the Real Character's 10 activities in the real world. In this said scenario the Über Character 20 has been wounded by the virtual dragon 22 and calls upon the Real Character 10 for assistance 24—HELP! I'VE BEEN HIT! I NEED MAGIC POTION NOW! YOU MUST HELP ME. In the embodiment shown (FIG. 1A) the virtual antidote 26 is displayed on the playing screen 18 as a particular beverage or a particular beverage vessel available at a particular vendor indicated in this case by an M 28, understood for the purposes of this description only as MacDonald®. The Real Character 10 is encouraged to acquire such a particular real beverage 30 from the vendor M 32. In the example shown in FIG. 1A the method of acquirement is by physically traveling 34 to the location 36 of the vendor 32 and purchasing the real beverage 30. The physical presence of the Real Character 10 in the physical location 36 of the vendor 32 is recorded, in the example shown in FIG. 1A, by means of a web-camera 38 in communication with a computer 40 which is further in communication with a server 42. The server 42 is in communication with the Internet. The Real Character 10 identity and location 36 are identified by a variety of means including digital image analysis of a game user-specific identity tag worn by the Real Character 10, and digital image analysis of the Real Characters face. Such digital analysis can be performed either on the PC located at the vendor's location 36 or on a non-local server 42. Other methods for determining the Real Character's identity and location include methods of payment such as credit card, entry of personalized code at point-of-sale, location tracking of a mobile device transported with the Real Character by means such as GPS, Bluetooth, cell tracking. These and further methods are described hereinabove and further in FIG. 11.

It is understood that the present invention as embodied in FIG. 1A equally describes the situation in which the Real Character 10 communicates to the vendor 32, by means including telephone, facsimile, e-mail, Short Messaging Service (SMS) and Internet, of the Real Character's 10 desire for the beverage 30 to be delivered to the Real Character. The Real Character's 10 identity and the location details of the vendor 32 are relayed to the gaming management server 14 by methods including the vendor registering the event on the vendor's location-based computer 40, a vendor delivery agent registering the event by means of a wireless device, and the Real Character 10 registering the event via the computer 12.

FIG. 1B shows the Real Character 10 returning from the vendor's location 36. The Real Character 10 resumes direct interaction with the gaming environment 16 via the PC 12. The information pertaining to the Real Character having acquired the beverage 30 at a specific location 36 is communicated to the gaming management server 14 and interpreted by the gaming management rules software located therein as an antidote for the Über Character 20 within the virtual gaming environment. The Über Character 20 is shown 16 cured of his injury and standing triumphant over the defeated dragon 22. The Über Character announces 44 that YOU DRANK THE POTION. I BEAT THE DRAGON.

FIG. 1C shows the embodiment wherein the Über Character 20 within the gaming environment 16 announces 46 to the Real Character 10—THANK YOU FOR SAVING ME. The facial characteristics of the Über Character 20 change to those of the Real Character 10 thus affording close identification between the Real Character 10 in the real world and the Über Character in the virtual world.

FIG. 2A illustrates a Real Character 10 involved in a form of entertainment accessed via a desktop PC 12 in communication with a game management server 14. Shown in the enlarged detail 16 of the computer screen 18 is a scene from an imaginary game involving an Über Character 20 facing a menacing virtual dragon 22. In this said scenario the Über Character 20 has been trapped by the virtual dragon 22 and calls upon the Real Character 10 for assistance 48—I NEED A MAGIC SWORD. YOU MUST HELP ME! QUICK! In the embodiment shown (FIG. 2A) an accounting menu 50 appears displaying the present status of the Real Character's 10 virtual point account. In this scenario the Real Character 10 is informed that there are 1000 points on account and that the required magic sword requires a further 200 points which can be obtained by acquiring a drink of a particular beverage 30 available at a particular vendor M 32, understood for the purposes of this description only as MacDonald®. In the example shown in FIG. 2A the method of acquirement is by physically traveling 34 to the location 36 of the vendor 32 and purchasing the real beverage 30. The physical presence of the Real Character 10 in the physical location 36 of the vendor 32 is recorded, in the example shown in FIG. 2A, by means of a web-camera 38 in communication with a computer 40 which is further in communication with a server 42. The server 42 is in communication with the Internet. The Real Character 10 identity and location 36 are identified by a variety of means including digital image analysis of a game user-specific identity tag worn by the Real Character 10, and digital image analysis of the Real Character's face. Such digital analysis can be performed either on the PC located at the vendor's location 36 or on a non-local server 42. Other methods for determining the Real Character's identity and location include methods of payment such as credit card, entry of personalized code at point-of-sale, location tracking of a mobile device transported with the Real Character by means such as GPS, Bluetooth, cell tracking. These and further methods are described hereinabove and further in FIG. 11.

It is understood that the present invention as embodied in FIG. 2A equally describes the situation in which the Real Character 10 communicates to the vendor 32, by means including telephone, facsimile, e-mail, SMS and Internet, of the Real Character's 10 desire for the beverage 30 to be delivered to the Real Character The Real Character's 10 identity and the location details of the vendor 32 are relayed to the gaming management server 14 by methods including the vendor registering the event on the vendor's location-based computer 40, a vendor delivery agent registering the event by means of a wireless device, and the Real Character 10 registering the event via the computer 12.

FIG. 2B shows the Real Character 10 returning from the vendor's location 36. The Real Character 10 resumes direct interaction with the gaming environment 16 via the PC 12. The information pertaining to the Real Character having acquired the beverage at a specific location 36 is communicated to the gaming management server 14 and interpreted by the gaming management rules software located therein as 200 points credited to the Real Character's 10 account. An accounting menu 52 shows that the Real Character 10 now has the required number of points on account to provide the [symbol] ber Character 20 with the necessary magic sword.

The [symbol] ber Character 20 is shown in the gaming scenario 16 with the magic sword 54 in hand standing triumphant over the defeated dragon 22. The [symbol] ber Character announces 54 that I BEAT THE DRAGON.

FIG. 2C shows the embodiment wherein the [symbol] ber Character 20 within the gaming environment 16 announces 58 to the Real Character 10 - THANK YOU FOR HELPING ME. The facial characteristics of the [symbol] ber Character 20 change to those of the Real Character 10 thus affording close identification between the Real Character 10 in the real world and the [symbol] ber Character in the virtual world.

From the embodiments illustrated in FIGS. 2A-2C it can be noted that it is not necessary for there to be a real-time correlation between the real world actions and the effect in the virtual world since, e.g., in this embodiment the [symbol] ber Character 20 acquires the necessary magic sword based on points which have been accumulated for past as well as present real-world actions of the user. Furthermore, from a comparison of the embodiments illustrated in FIGS. 1A-1C and 2A-2C it will be understood that an action in the real-world can result in different randomized effects in the virtual world depending on the specific game rules, e.g., in FIGS. 1A-1C acquiring real beverage provides the [symbol] ber Character 20 with the necessary antidote 26 to be cured of his injury while in FIGS. 2A-2C acquiring real beverage 30 provides the [symbol] ber Character with sufficient cumulative points to acquire the necessary magic sword.

FIG. 3A illustrates a Real Character 10 involved in a form of entertainment accessed via a desktop PC 12 in communication with a game management server 14. Shown in the enlarged detail 16 of the computer screen 18 is a scene from an imaginary game involving an [symbol] ber Character 20 facing a menacing virtual dragon 22. In this said scenario the [symbol] ber Character 20 has been wounded by the virtual dragon 22 and calls upon the Real Character 10 for assistance 59—HELP! I'VE BEEN HIT! I NEED MAGIC POTION NOW! YOU MUST HELP ME. In the embodiment shown (FIG. 3A) the virtual antidote 26 is displayed on the playing screen 18 as a particular beverage or a particular beverage vessel available at a particular vendor indicated in this case by an M 28, understood for the purposes of this description only, as MacDonald®. The Real Character 10 is encouraged to acquire such a particular real beverage 30 from the vendor M 32 for the purposes of aiding the [symbol] ber Character 20. In the example shown in FIG. 3A, unlike examples shown in FIG. 1A and FIG. 2A, the Real Character 10 delegates, by some means (not specified), the acquirement of the beverage to another Real Character 60 that is in some way associated with the game environment. The Real Character 60 physically travels 34 to the location 36 of the vendor 32 and purchases the real beverage 30. The physical presence of the Real Character 60 in the physical location 36 of the vendor 32 is recorded, as in the example shown in FIG. 1A, by means of a web-camera 38 in communication with a computer 40 which is further in communication with a server 42. The server 42 is in communication with the Internet. The Real Character's 60 identity and location are identified by a variety of means including digital image analysis of a game user-specific identity tag worn by the Real Character 60, and digital image analysis of the Real Character's 60 face. Such digital analysis can be performed either on the PC located at the vendor's location 36 or on a non-local server 42. Other methods for determining the Real Character's 60 identity and location include methods of payment such as credit card, entry of personalized code at point-of-sale, location tracking of a mobile device transported with the Real Character 60 by means such as GPS, Bluetooth, cell tracking. These and further methods are described hereinabove and further in FIG. 11.

Thus the Real Character 10 does not himself travel nor does the Real Character 10 make any purchase. The Real Character 60 is associated with the Real Character 10 through a variety of means such as a proxy, team member for the particular virtual gaming world that Real Character 10 is currently involved with, and a member of the general gaming environment that, even though he may be involved in another virtual gaming world, is able to influence the particular virtual gaming world of Real Character 10 due to the cross-coupling of differing virtual worlds as described in FIG. 7.

FIG. 3B shows the information pertaining to the Real Character 60 having acquired the beverage 30 at a specific location 36 is communicated to the gaming management server 14 and interpreted by the gaming management rules software located therein as an antidote for the [symbol] ber Character 20 within the virtual gaming environment of Real Character 10. The [symbol] ber Character 20 is shown 16 cured of his injury and standing triumphant over the defeated dragon 22. The [symbol] ber Character announces 62 that WOW! THAT WAS LUCKY! WELL DONE TEAM!

FIG. 3C shows the embodiment wherein the [symbol] ber Character 20 within the gaming environment 16 announces 64 to the Real Character 10—THANK YOU ALL FOR HELPING ME. The facial characteristics of the [symbol] ber Character 20 change to those of the Real Character 10 thus affording close identification between the Real Character 10 in the real world and the [symbol] ber Character 20 in the virtual world.

FIG. 4A illustrates an embodiment which differs from that in FIG. 1A, FIG. 2A and FIG. 3A in that the Real Character 10 is not directly prompted by a gaming scenario to act in response to a virtual crisis in the virtual world which is accessed via the desktop PC 12 in communication with the game management server 14. The Real Character 10 is shown in FIG. 4A in two different scenarios both away from the desktop PC 12. In one scenario 64 the Real Character 10 is meeting with another Real Character 60. Real Character 10 has in his possession a PDA such as a Palm Pilot® 66 and Real Character 60 has in his possession a cellular phone device 68. Real Character 10 is a participant of the entertainment system managed by the game management server 14. Real Character 60 may or may not be a participant in such an entertainment system managed by the game management server 14. Alternatively Real Character 60 may be a participant in another entertainment system managed by another game management system (not shown) that may have a sharing-of-points arrangement with the entertainment system managed by the game management server 14. In FIG. 4A the PDA 66 is equipped with short range communication hardware such as an infrared beam or a Bluetooth rf transceiver. The cellular phone device 68 is similarly equipped with short range communication hardware such as an infrared beam or a Bluetooth rf transceiver. When Real Character 10 meets Real Character 60 there is an exchange of information 70 between the two devices. This exchange is either automated through the Bluetooth connection or manually by both Real Characters simultaneously aligning the infrared ports. The information communicated is of a variety of forms including information not directly relevant to the gaming environment such as personal details, and information that is directly relevant to the gaming environment such as electronic coupons, virtual swords, magic portions, and virtual food. During any such exchange of information the gaming ID's of both Real Characters (10 and 60) are automatically exchanged 70 and passed onto the gaming management server 14 either directly by wireless communication 72 or indirectly such as synching of the PDA to the desktop PC 12, as shown in FIG. 4B. The location of the cellular phone 68 is tracked by estimating the closest transceiver cells and the information is relayed to the gaming management server 14 together with the gaming ID's of the Real Characters (10 and 60) and the content of any gaming specific information that was exchanged 70 between the two Real Characters (10 and 60).

In a second scenario (74) the Real Character 10 is ordering a drink 30 at a vendor 32 designated by M. The physical presence of the Real Character 10 in the physical location 36 of the vendor 32 is recorded, in the example shown in FIG. 1A, by means of a web-camera 38 in communication with a computer 40 which is further in communication with a server 42. The server 42 is in communication with the Internet. The Real Character 10 identity and location are identified by a variety of means including digital image analysis of a game user-specific identity tag worn by the Real Character 10, and digital image analysis of the Real Character's face. Such digital analysis can be performed either on the PC located at the vendor's location 36 or on a non-local server 42. Other methods for determining the Real Character's identity and location include methods of payment such as credit card, entry of personalized code at point-of-sale, location tracking of a mobile device 66 transported with the Real Character 10 by means such as GPS, Bluetooth, cell tracking. These and further methods are described hereinabove and further in FIG. 11.

FIG. 4B shows the Real Character 10 with the PDA 66 returning to resume direct interaction with the gaming environment 16 via the PC 12. The actions performed by the Real Character 10 from encounters 64 and 74, as shown in FIG. 4A, are communicated to the gaming management server 14 by downloading the relevant information from the PDA 66 to the PC 12. Such communication occurs by methods such as wireless Bluetooth communications and wired communications (synching). The data is then transferred to the gaming management server 14 and interpreted by the gaming management rules software located therein. Alternatively the necessary gaming management rules software in resident in the PC 12. The appropriate number of gaming points is allotted to Real Character's 10 virtual gaming environment.

The [symbol] ber Character 20 is shown 16 under attack by the dragon 22. The [symbol] ber Character 20 calls 76 to the Real Character 10 from within the virtual gaming world—I NEED A MAGIC SWORD! I HOPE THAT WE HAVE ENOUGH POINTS? A points' menu appears 78 showing that the Real Character 10 has accumulated the necessary number of points to enable the [symbol] ber Character 20 to acquire a magic sword to battle the dragon 22.

FIG. 4C shows the [symbol] ber Character 20 standing triumphant over the defeated dragon 22. The [symbol] ber Character announces 80 that WITH 1600 POINTS I BEAT THE DRAGON.

FIG. 5A differs from FIGS. 1A, 2A, 3A and 4A in that the virtual gaming interface with the real world is via a PDA 66. FIG. 5A illustrates a Real Character 10 involved in a form of entertainment accessed via a PDA 66 in wireless communication 82 with a game management server 14. Shown in the enlarged detail 16 of the computer screen 84 is a scene from an imaginary game involving an [symbol] ber Character 20 facing a menacing virtual dragon 22. In this said scenario the [symbol] ber Character 20 has been wounded by the virtual dragon 22 and calls upon the Real Character 10 for assistance 88—HELP! I'VE BEEN HIT! I NEED MAGIC POTION NOW! YOU MUST HELP ME. In the embodiment shown (FIG. 5A) the virtual antidote 26 is displayed on the playing screen 84 as a particular beverage 28 or a particular beverage vessel available at a particular vendor indicated in this case by an M, understood for the purposes of this description only as MacDonald®. The Real Character 10 is encouraged to acquire such a particular real beverage 30 from the vendor M 32. In the example shown in FIG. 5A the method of acquirement is by physically traveling 34 to the location 36 of the vendor 32 and purchasing the real beverage 30. The physical presence of the Real Character 10 in the physical location 36 of the vendor 32 is recorded, in the example shown in FIG. 5A, by means of communication from the PDA 66. Such communication can be accomplished by a Bluetooth transceiver (not shown) attached to or incorporated into the PDA 66 and a Bluetooth access point 90 in communication with a computer 40 which is further in communication with a server 42. Alternatively communications between the PDA 66 and the computer 40 can take place via infrared data beaming. The server 42 is in communication with the gaming management server 14 via the Internet. Alternatively the location and identity of the Real Character 10 can be transmitted directly 92 to the gaming management server via the Internet using a wireless modem attached to or incorporated with the PDA 66.

FIG. 5B shows the Real Character 10 leaving the proximity of the vendor 32. The Real Character 10 resumes interaction with the gaming environment 16 via the PDA 66. The information pertaining to the Real Character 10 having acquired the beverage 30 at a specific location 36 is communicated to the gaming management server 14 and interpreted by the gaming management rules software located therein as an antidote for the [symbol] ber Character 20 within the virtual gaming environment. The updated scenario is transmitted wirelessly 94 to the PDA 66. The [symbol] ber Character 20 is shown 16 cured of his injury and standing triumphant over the defeated dragon 22. The [symbol] ber Character announces 96 that YOU DRANK THE POTION. I BEAT THE DRAGON.

FIG. 6 shows a simplified block diagram illustrating the two dimensions of existence which are defined and related to in the present invention: the Real World 100 with Real Characters 10 or users and the Virtual World 104 with [symbol] ber Characters 20 or Virtual Characters.

The interface between the Real World 100 and the Virtual World 104 is via a computer system 14.

FIG. 7 is a flow diagram describing the general flow of information for the non-correlative influence of the Real World 100 on the Virtual World 104. A Real Character-2 10 in the Real World 100 performs an Action-2 112 in the Real World 100. This Action-2 112 includes purchasing in a real shop, exchanging information with others, traveling to a specified location, and participating in a particular event. Such an Action-2 112 creates a Virtual Action Identifier (VAI)-2 114 that consists of a transferable data set capable of being transmitted to a web-based server 14. The data set includes the following fields: unique identifier of action type; unique identifier of action detail; time of action; location of action; exchange identifier; Real Character identifier. The VAI crosses the real/virtual divide 116 and is received and processed by the server 14. The server cross-references the fields in the data set against look-up tables in the data-base resident on the server 14. The outcome of this cross-referencing is a Consequence 118. The Consequence 118 consists of a set of commands. The Consequence 118 can be further modified by similar events on other parallel servers 14. The result is a confluence of Consequences 118, which in turn become an Influence 120 on one or more Virtual Worlds 122. This Influence 120 will affect various aspects of the Virtual World 122 including, character profiles, scenery, movement, and interaction.

The Virtual World-2 122 sends a Description Subset-2 124 back to the Server 14 with specific address flags (1, 2, 3 . . . ) for each Real Character 10. The Description Subset 124 can further be modified by other Virtual Worlds 122 resulting in a subset{VW1, VW2, VW3 . . . }. The Description Subset 124 is directed by the Server 14 to the appropriate address and passes through the real/virtual divide 116. The Real Character-2 10 receives the Description-2 126 on a web enabled device including a desktop PC with a land-line modem, a mobile computer with a wireless modem, a PDA with a wireless modem, and a WAP phone.

As a result of the Description-2 126 the Real Character-2 10 recognizes a change in the Virtual World-2 122 scenario. This then prompts the Real Character-2 10 to initiate a response in the form of a Consequence 128 that then leads to a further Action 112.

FIG. 8 shows a block diagram of a preferred embodiment wherein a Real Character 10 in the Real World 100 possess a handheld, mobile, web-enabled device 130 such as a PDA, laptop computer, pocket computer, and WAP phone. The Real Character 10 is also a participant in a Virtual World Gaming Scenario 122 the back end of which is resident on an Internet server 14 and the front end of which is displayed on the display screen of the device 130. Gaming scenarios include, multi-character games, multi-user games, interactive games, solo games, single character games, competitive and non-competitive games, and [symbol] ber-Characters 20 (FIG. 5A). In order to influence the game in the Virtual World 104 the Real Character 10 needs to act in the Real World 100. Such Actions 112 (FIG. 7) include commerce 132, places 134, people 136, and events 138.

For instance, and by way of example only, the [symbol] ber-Character 20 (FIG. 5A) in a Virtual World Gaming Scenario 122 is in need of nutrition 140. In order to supply this character with the necessary virtual nutrition 140 the Real Character 10 has to go to a restaurant, chosen from a specified set of restaurants, and purchase a meal.

Other elements that are consequential to the Virtual World Gaming Scenario 122 include Clues 142, Interactions 144, Movement 146, Scenery 148, Characters 150, Weapons 152 such as a magic sword 54 (FIG. 2C), and Energy 154.

FIG. 9 shows a block diagram of the method of transferring the Virtual Action I.D. (VAID) to the server 14 (FIG. 8). The commercial transaction is relayed to the server by the transfer of a data set containing fields including, the Transaction Class 162, the Real Character's ID 164, the Vendor's name and address 166, and size of commercial transaction (Amount) 168, in this example, the cost of the meal, and the Transaction Time 170. Examples of Transaction Class 162 are included: food, merchandise, information, and places.

Within the server 14 (FIG. 8) each field of the VAID is matched on a look-up table 172 to a value system. Each field in the VAID data set 160 contributes a fraction of the total value according to a defined currency conversion rate listed in the lookup tables 172 for each field. The accumulation of points results in a Consequence 118 that then Influences 120 (FIG. 7) the Virtual World Gaming Scenario 122 (FIG. 7). In the preferred embodiment these points act as virtual gaming currency (VEC) that can be transferred from Virtual World Gaming Scenario 122 (FIG. 7) to Virtual World Gaming Scenario 122 (FIG. 7). The lookup tables 160 are continuously updated to reflect such variables as special offers, special activities, special situations, Actions 112 (FIG. 7) of other Real Characters 10 (FIG. 7) and states of other Virtual World Gaming Scenarios 122 (FIG. 7).

The output of the Transaction Class 162 is also a variable and not necessarily a one-to-one correspondence. Thus a food transaction doesn't necessarily result 174 in food VGC (Q(_{food})vₓ). A transaction at a particular place or at a particular time or of a particular value or by a particular Real Character 10 (FIG. 7) may result in any one of a set of classes that is determined by the gaming scenario, and reflected in the lookup table 160 at the time the transaction is registered. In the preferred embodiment the resulting Transaction Class Q can be converted to other classes within the rules of the gaming scenario. In the preferred embodiment a Real Character 10 (FIG. 5A) pays for the meal by e-cash downloaded from a web-enabled PDA 66 (FIG. 5A) by Bluetooth transmission to the patron's computerized, on-line cash registrar 40 (FIG. 5A). A receipt is transferred back to the Real Character 10 (FIG. 5A) together with a Transaction Set 160. The VAID is wirelessly uploaded 94 (FIG. 5B) to the server 14 (FIG. 5B) from the PDA 66 (FIG. 5A). The VAID is also transferred from the patron's computer 40 (FIG. 5A) to the server 14 (FIG. 5A) were the two data sets are matched for the purposes of authentication. Once the server 14 (FIG. 5A) has authenticated the transaction the VAID is matched to the lookup tables 160 according to their assigned values at that moment.

By way of continuing the example: food 162, in this case a beverage, consumed at MacDonald® of 5th Ave 22^{nd} St. 166, for the amount of $4 168 on 12^{th} July at 12:00 pm 170 by Real Character I.D. 98765 164 results in a VGC of V food units 174. The Real Character 10 (FIG. 5B) is notified of this VGC acquisition on the Real Character's PDA 66 (FIG. 5B). The Real Character 10 (FIG. 5B) has the choice to convert the food units into another class of units but since, in this example, the [symbol] ber-Character 20 (FIG. 5B) is in need of virtual food the Real Character 10 (FIG. 5B) declines the conversion opportunity. The VGC of V food units are assigned to the relevant Virtual World Gaming Scenario 122 (FIG. 8). The [symbol] ber-Character 20 (FIG. 5B) receives its virtual food and is virtually satiated. A Description 126 (FIG. 7) of this Influence 120 (FIG. 7) on the Virtual World Gaming Scenario 122 (FIG. 7) returns to the server 14 (FIG. 7) and appears on the PDA 66 (FIG. 5B) of the Real Character (FIG. 5B) in the relevant gaming format. As a Consequence 128 (FIG. 7), the Real Character 10 (FIG. 7) may then be moved to initiate another Action 112 (FIG. 7) type in order to Influence 120 (FIG. 7) the game further.

FIG. 10 is a block diagram showing the various pathways that a Vendor 36 can relay a VAID to the server 14. The relay can occur along several pathways including direct 176,178 and indirect 180. For a direct relay 176, 178 the data set 160 (FIG. 9) is passed directly from the vendor 36 to the server 14 via the vendor's web enabled device including a desktop computer 40 (FIG. 5A) with a land-line modem, a mobile device with a wireless modem, and SMS over a cellular phone network via a SMS gateway 182. An indirect transfer 180 occurs when the data set 160 (FIG. 9), created by the transaction, is first passed from the vendor's digital device 40 (FIG. 5A) to the Real Character's mobile device 66 (FIG. 5A). This is performed by means including IR transmission, rf transmission, wired synching, scanning a coded voucher and manual input of a transaction code. If the mobile device 66 (FIG. 5A) is web-enabled then the VAID is passed directly 94 onto the server 14. If the mobile device is a cellular telephone 68 (FIG. 4B) then upon dialing a specified user number, such as a 1-800 number, the VAID, in the form of an alphanumeric code, is entered via the phone keypad. Alternatively the VAID is sent as an SMS message 184. If the mobile device 66 (FIG. 4A) is not web-enabled then the VAID is passed on to a web-enabled device such as a desktop PC 12 (FIG. 4B) by such means as IR transmission, rf transmission, and wired synching 186. From there it is transmitted by land-line modem 188 to the server 14. An alternative method of indirect transfer of the VAID from the vendor 36 to the server 14 is via a voucher 190 issued by the vendor. The voucher contains an encoded data set 160 (FIG. 9) in the form including an alphanumeric string, a magnetic strip, a smart card and a bar code. The VAID encoded in the voucher can be transferred to a web enabled device, such as a desktop PC 14 (FIG. 4A), by means including: keypad strokes of the alphanumeric code, a magnetic swipe device, a smart card reader and a bar-code scanner. The VAID is then passed on to the server 14 as previously described.

FIG. 11 is a block diagram showing different means whereby the location of the Real Character 10 (FIG. 4A) in possession of a mobile device 192 such as a PDA 66 (FIG. 4A) or cellular telephone 68 (FIG. 4A) is made. Thus Location Identification Virtual Gaming Currency is acquired by the Real Character's 10 (FIG. 4A) presence at specified geographic locations (FIG. 4A). The whereabouts of the Real Character 10 (FIG. 4A) are tracked by methods including Global Positioning System (GPS), cellular phone location technologies 196 including Time of Arrival (TOA), Enhanced Observed Time Difference (E-OTD), and Cell of Origin (COO), Bluetooth Personal Access Network (BT-PAN) 198, IR transmission 200, hard-wire synching 202, manual entry of address 204, manual code entry from printed vouchers 206. FIG. 11 shows the Gaming Management Server 14 able to locate a mobile device 176 using a plurality of such means. By way of example only, a Bluetooth transmitter located at a fixed location 208 communicates the location via a Bluetooth receiver 198 in the mobile device 192. In exchange the mobile device transmits back the Real Character's I.D. This data set is relayed onto the gaming system's server 14. The coordinates acquired by the mobile device 192 are also transmitted via the wireless modem 210 and relayed to the gaming system's server 14. This double pathway acts as a confirmation mechanism. It is clear to one skilled in the art that only one of these location methods and only one of these pathways are necessary for the server 14 to pin-point the whereabouts of the Real Character 10 (FIG. 4A).

In the embodiment described in FIG. 11, and by way of example only, a Real Character 10 (FIG. 4A) plays out a scavenger hunt in the Real World 100 (FIG. 7) that influences the movements of the [symbol] ber-Character 20 (FIG. 4A) in the Virtual World Game Scenario 122 (FIG. 7). The Real Character 10 (FIG. 4A) travels to a specified geographic location say a statue situated in the center of a shopping mall. The Real Character's 10 (FIG. 4A) position is monitored by a GPS tracking system 194 built into the mobile device 192 and relayed from there to the gaming system's server 14 via the wireless modem 210. When the Real Character 10 (FIG. 4A) enters the shopping mall the tracking method switches from GPS 194, which is ineffective indoors, to Bluetooth transceivers 208 situated in various locations in the mall. The whereabouts of the Real Character 10 (FIG. 4A) is relayed back to the gaming system's server 14 by the fixed-point Bluetooth transceiver 208 as well as by the wireless modem 210 of the mobile device 192. Upon reaching the statue a VGC of V magic units are assigned to the relevant Virtual World 122 (FIG. 7). The affects on the Virtual World Gaming Scenario 122 (FIG. 7) would be, by way of example, the opening of a secret passageway that allows the [symbol] ber-Character 20 (FIG. 4B) to acquire a magic sword 54 (FIG. 4B) or to enter another level of the game. A Description 124 (FIG. 7) of this Influence 120 (FIG. 7) on the Virtual World Gaming Scenario 122 (FIG. 7) returns to the Gaming Server 14 and appears on the PDA 66 (FIG. 4B) of the Real Character 10 (FIG. 4B) in the relevant gaming format. As a Consequence 128 (FIG. 7), the Real Character 10 (FIG. 4B) may then be moved to initiate another Action 112 (FIG. 7) type in order to Influence 120 (FIG. 7) the game further.

A further example is given by a variation of the popular board game Monopoly™ in which, instead of a Real Character 10 (FIG. 4A) throwing dice to advance the position of a playing piece on the board that determines whether property can be bought or not, the Real Character 10 (FIG. 4A) must actually arrive at a particular destination in the Real World 100 (FIG. 7) in order to move the playing piece in Virtual World 104 (FIG. 7).

Referring back to the preferred embodiment as described in FIG. 8. A still further method for the Real Character 10 to obtain VGC and thereby influence the Virtual Gaming Scenario 122 is through interactions with other Real Characters 60 (FIG. 4A) in real meetings 136. Such Real Characters 60 (FIG. 4A) do not necessarily have to be participating in such games or even be part of the provider's system. By way of examples, VGCs are obtainable by exchanging electronic business cards by IR beaming 200 (FIG. 9) from one device to another, or by being present at a defined location 134 with others such as meeting for a meal at a participating restaurant. Furthermore one-to-one meetings can result in the transfer of VGCs and other pieces of data that are capable of influencing the Virtual Game Scenario. Furthermore VGCs can be obtained as a result of playing interactive wireless games between a plurality of players using their mobile devices. In this case points gained in one gaming environment are used to influence another environment. This influence can also be multi-directional, in that the status of the [symbol] ber-Character 20 (FIG. 4A) can, for example lend strength or equipment to another interactive gaming character that is not necessarily an [symbol] ber-Character. The VGCs are transferred either directly 94 (FIG. 5B) from the Real Character's 10 (FIG. 4A) device to the gaming server 14 or indirectly 72 (FIG. 4A) via the other Real Character 60 (FIG. 4A) device 68 (FIG. 4A).

Another aspect of the preferred embodiment shown in FIG. 8 is the acquirement of VGCs according to a time-based event 138 thus adding another dimension to each of the previously described methods of acquisition. Thus if a commercial transaction, for instance, is performed during a specific time slot the VAID influence upon the Virtual World will be different than if it was performed during another time slot. Likewise, arriving at a specific location at one time will create a VAID different from another time. This is also true for meeting with other people. So by way of example only: a Real Character 10 (FIG. 4A) having a beverage 30 (FIG. 4A) at MacDonald® 36 (FIG. 4A) between 8 am and 10 am will receive VGCs leading to a VAID that will result in an [symbol] ber-Character 20 (FIG. 4B) receiving an increase in energy level, whereas a beverage 30 in the identical establishment between 8 pm and 10 pm will result in the [symbol] ber-Character 20 (FIG. 4B) losing a piece of equipment. The VGC is relayed to the gaming server 14 by means already described herein and understood by one skilled in the art.

FIGS. 12,13,14 and 15 are further embodiments of the block diagram shown in FIG. 8 that describe the accumulation of VGCs by the non-correlative influence of the Real World 100 on the Virtual World 104 where the Virtual World Gaming Scenario 122 is primarily resident on different platforms.

FIG. 12 shows a block diagram of an alternative embodiment wherein a Real Character 10 in the Real World 100 possess a handheld, mobile, web-enabled device 130 such as a PDA, laptop computer, pocket computer, and WAP phone. The Real Character 10 is also a participant in a Virtual World Gaming Scenario 122 in the Virtual World 104 which resides primarily on the mobile device 130. The Internet server 14 is a collector of VGCs for the mobile device 130. Gaming scenarios include, multi-character games, multi-user games, interactive games, solo games, single character games, competitive and non-competitive games, and [symbol] ber-Characters 20 (FIG. 5A). In order to influence the game in the Virtual World 104 the Real Character 10 needs to act in the Real World 100. Such Actions 112 (FIG. 7) includes commerce 132, places 134, people 136, and events 138.

For instance, and by way of example only, the [symbol] ber-Character 20 (FIG. 5A) in a Virtual World Gaming Scenario 122 is in need of nutrition 140. In order to supply this character with the necessary virtual nutrition 140 the Real Character 10 has to go to a restaurant, chosen from a specified set of restaurants, and purchase a real food.

Other elements that are consequential to the Virtual World Gaming Scenario 122 include Clues 142, Interactions 144, Movement 146, Scenery 148, Characters 150, Weapons 152 such as a magic sword 54 (FIG. 2C), and Energy 154.

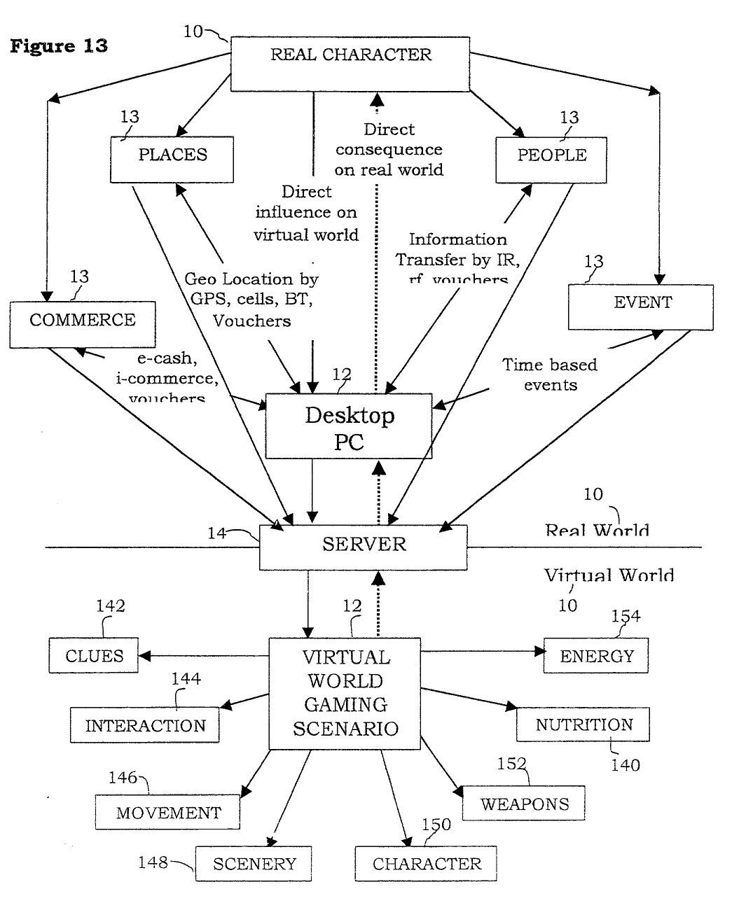

FIG. 13 shows a block diagram of a preferred embodiment wherein a Real Character 10 in the Real World 100 possess Desktop PC 12. The Real Character 10 is also a participant in a Virtual World Gaming Scenario 122 the back end of which is resident on an Internet server 14 and the front end of which is displayed on the display screen of the PC 18 (FIG. 1A). Gaming scenarios include, multi-character games, multi-user games, interactive games, solo games, single character games, competitive and non-competitive games, and [symbol] ber-Characters 20 (FIG. 1A). In order to influence the game in the Virtual World 104 the Real Character 10 needs to act in the Real World 100. Such Actions 112 (FIG. 7) includes commerce 132, places 134, people 136, and events 138.

For instance, and by way of example only, the [symbol] ber-Character 20 (FIG. 1A) in a Virtual World Gaming Scenario 122 is in need of nutrition 140. In order to supply this character with the necessary virtual nutrition 140 the Real Character 10 has to go to a restaurant, chosen from a specified set of restaurants, and purchase a real food. The VGC associated with the particular Action 112 (FIG. 7) is relayed by the Vendor 36 (FIG. 1A) directly to the server 14 or VGC is transferred to the Real Character 10 by means of vouchers or non-web enabled PDAs. The Real Character 10 transfers the contents of the VGC to the PC 12 by means described hereinabove. From the PC 12 the data is transferred to the Server 14.

Other elements that are consequential to the Virtual World Gaming Scenario 122 include Clues 142, Interactions 144, Movement 146, Scenery 148, Characters 150, Weapons 152 such as a magic sword 54 (FIG. 2C), and Energy 154.

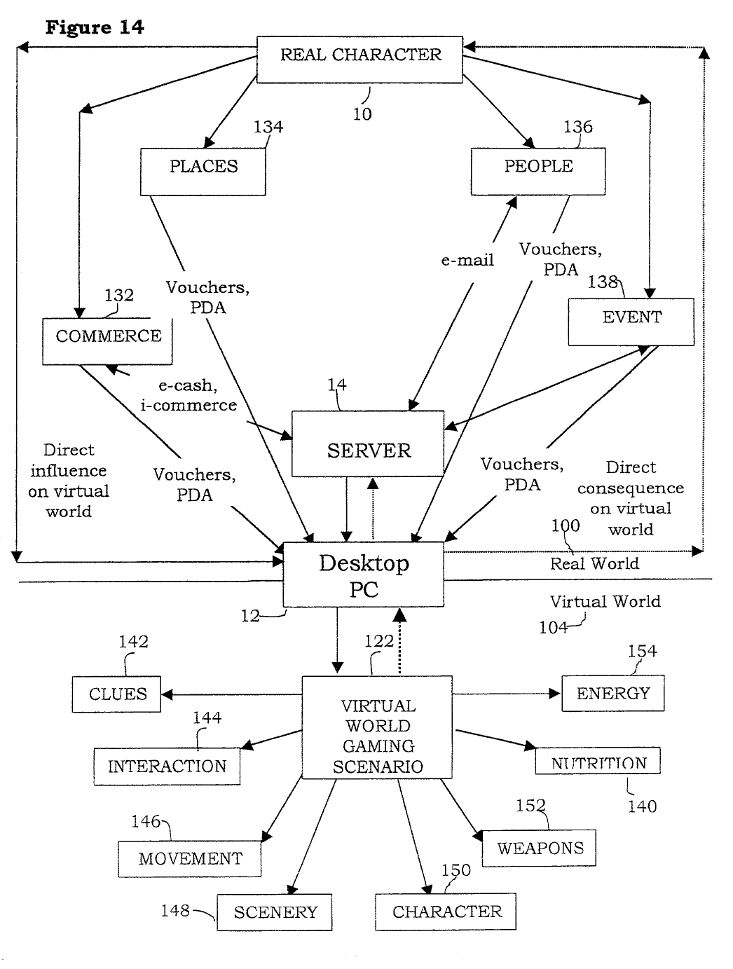

FIG. 14 shows a block diagram of an alternative embodiment wherein a Real Character 10 in the Real World 100 possess desktop PC 12. The Real Character 10 is also a participant in a Virtual World Gaming Scenario 122 in the Virtual World 104 which resides primarily on PC 12. The Internet server 14 acts as a conduit of VGCs for PC 12. Gaming scenarios include, multi-character games, multi-user games, interactive games, solo games, single character games, competitive and non-competitive games, and [symbol] ber-Characters 20 (FIG. 1A). In order to influence the game in the Virtual World 104 the Real Character 10 needs to act in the Real World 100. Such Actions 112 (FIG. 7) includes commerce 132, places 134, people 136, and events 138.

For instance, and by way of example only, the [symbol] ber-Character 20 (FIG. 1A) in a Virtual World Gaming Scenario 122 is in need of nutrition 140. In order to supply this character with the necessary virtual nutrition 140 the Real Character 10 has to go to a restaurant, chosen from a specified set of restaurants, and purchase a real food.

Other elements that are consequential to the Virtual World Gaming Scenario 122 include Clues 142, Interactions 144, Movement 146, Scenery 148, Characters 150, Weapons 152 such as a magic sword 54 (FIG. 2C), and Energy 154.

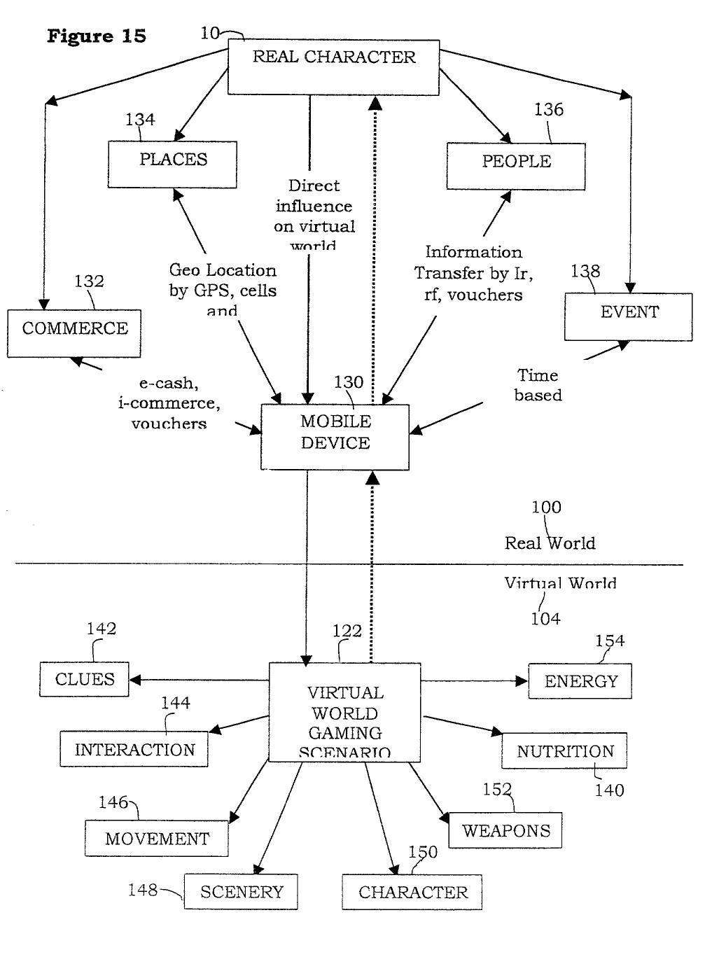

A further embodiment is shown in FIG. 15 where there is no server and the mobile device 130 is not web-enabled. In such a scenario the Virtual Gaming environment 122 is located solely on the mobile device 130. Gaming scenarios include, multi-character games, multi-user games, interactive games, solo games, single character games, competitive and non-competitive games, and [symbol] ber-Characters 20 (FIG. 1A). In order to influence the game in the Virtual World 104 the Real Character 10 needs to act in the Real World 100. Such Actions 112 (FIG. 7) includes commerce 132, places 134, people 136, and events 138. Input from the Real World 100 is by a variety of means including: IR transmission, rf transmission, GPS geo-location, manual input of alphanumeric codes, and scanning of vouchers.

By way of example: Pokeman®) is a very popular card game as well as an electronic game played on the Nintendo® GameBoy® device. This embodiment describes the influence of acquiring such cards in a Real World 100 interaction and transferring data contained on those cards to a Virtual Gaming Environment 122. Thus coded information embedded in a card obtained while playing Pokeman® cards with other Real Character 10 is entered into a Mobile Device 130 by methods including scanning and entering an alphanumeric string. This then Influences 120 (FIG. 7) the Virtual Gaming Environment 122.

Other elements that are consequential to the Virtual World Gaming Scenario 122 include Clues 142, Interactions 144, Movement 146, Scenery 148, Characters 150, Weapons 152 such as a magic sword 54 (FIG. 2C), and Energy 154.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A game system, incorporating co-existent interaction between a virtual character and a user in the real world, comprising a virtual character in a computer sub-system including a computer device and means for inputting real-world actions of a user in the real world into said sub-system, whereby actions of a user in the real world, at a pre-chosen real world location, other than correlative movements, are recorded and inputted into the computer sub-system and influence the character in the virtual world.

2. A game system, according to claim 1, wherein said system incorporates at least one locator device for noting the presence of the user at a pre-chosen location.

3. A game system, according to claim 1, wherein the real-world actions of more than one user are inputted into the device.

4. A game system, according to claim 1, wherein said computer device is a mobile-device.

5. A game system, according to claim 4, wherein said mobile-device is a digital mobile computer.

6. A game system, according to claim 4, wherein said computer device is Web-enabled.

7. A game system, according to claim 4, wherein mobile-device is provided with Bluetooth technology.

8. A game system, according to claim 1, wherein said inputting into said device is effected by means selected from the group consisting of IR transmission, rf transmission, wired synching, scanning and manual input.

9. A game system, according to claim 2, wherein said locator device includes means selected from a global positioning system, a differential global positioning system, server-side referencing, time of arrival detectors, enhanced observed time difference detectors, cell of origin detectors, IR transmitters, hard-wire synchronization means, manual entry of location means, manual code entry means and a Bluetooth personal access network and combinations thereof.

10. A game system, according to claim 9, wherein said at least one locator device includes a combination of a global positioning system and Bluetooth transmitters/receivers.

11. A game system, according to claim 1, wherein said computer device is a fixed-point PC with the virtual character resident locally in the PC.

12. A game system, according to claim 1, wherein said computer sub-system further comprises a server containing at least part of the logic of said game system.

13. A game system, according to claim 12, wherein said computer device is a mobile hand-held device and the interface between the virtual character and the real world is resident in said server whereby actions of the user in the real world are inputtable into at least one of said server and said computer device, with intercommunication between said hand-held device and said server.

14. A game system, according to claim 12, wherein said computer device is a desk-top PC and the interface between the virtual character and the real world is resident in said server whereby actions of the user in the real world are inputtable into at least one of said server and said computer device, with intercommunication between said desk-top PC and said server.

15. A game system, according to claim 12, wherein said computer device is a mobile hand-held device and the interface between the virtual character and the real world is resident in said mobile device whereby actions of the user in the real world are inputtable into at least one of said server and said computer device, with intercommunication between said desk-top PC and said server.

16. A game system, according to claim 12, wherein said computer device is a desk-top PC and the interface between the virtual character and the real world is resident in said desk-top PC whereby actions of the user in the real world are inputtable into at least one of said server and said computer device, with intercommunication between said desk-top PC and said server.

17. A game system according to claim 12 wherein said computer sub-system comprises a desk-top PC and a hand-held device.

18. A game system according to claim 17 wherein said desk-top PC and hand-held device are both provided with Bluetooth technology.

19. A game system, according to claim 1, wherein said influence of the user in the real world on the virtual character in the virtual world is expressed as an image of the user in the scenario of the virtual world.
